(19) United States
(12) Patent Application Publication
(10) Pub. No.: US 2006/0210678 A1
(43) Pub. Date: Sep. 21, 2006

(54) Procedure for the preservation of bananas

(76) Inventors: Miguel Vendrell Melich, Barcelona (ES); Javier Palomer Tarrides, Barcelona (ES); Irma Roig Villanova, Barcelona (ES)

Correspondence Address: WOLF BLOCK SCHORR AND SOLIS-COHEN LLP, 250 PARK AVENUE, NEW YORK, NY, 10177, US

(21) Appl. No.: 10/555,293

(22) PCT Filed: May 5, 2004
(86) PCT No.: PCT/IB04/01381

§ 371 Date: Nov. 2, 2005

(30) Foreign Application Priority Data
May 6, 2003 (ES) P-200301016

(51) Int. Cl. A23B 4/056

(52) U.S. Cl. 426/235

(57) ABSTRACT

The object of the invention is a procedure which permits delayed onset of ripening of bananas, while at the same time retaining suitable organoleptic and quality characteristics. The procedure is carried out in a non-controlled modified atmosphere, at a temperature between 12° C. and 22° C., at atmospheric pressure, in which pure nitrous oxide is introduced and mixed with ventilation air until a nitrous oxide concentration of 40 to 60% is obtained, and an oxygen concentration between 12% and 8%, respectively, depending on the concentration of nitrous oxide.

### FIELD OF THE INVENTION

This invention relates to a procedure for the preservation of bananas. In particular, it relates to a procedure for preserving bananas which is carried out in a non-controlled modified atmosphere, which includes nitrous oxide within a specific range of concentrations.

### BACKGROUND OF THE INVENTION

It is known that various procedures have been used in the state of the art to preserve fruits, by combining different concentrations of combinations of two or more of the following components: nitrous oxide, argon, oxygen, nitrogen, carbon dioxide and an inert gas.

The object of all such procedures is to delay the synthesis of ethylene and thereby delay the start of the fruit ripening process.

In particular, the French patent in the name of L'Air Liquide, FR 1.582.927, relates to a procedure and device for preservation of fruit, and especially grapes. This patent discloses a procedure carried out in a refrigerated atmosphere, especially from 0° C. to 4 or 5° C., in which there exists a rarefication of oxygen and elimination of at least some of the carbonic gas generated by the fruit, characterised in that said atmosphere is maintained, at atmospheric pressure, essentially rich in nitrous oxide at a concentration ranging between 50% and 90%, mixed with oxygen at a concentration between 6% and 20%, the part eventually remaining being essentially made up of nitrogen and a small amount of carbonic gas.

More specifically, all the examples shown in this French patent use an 80% concentration of nitrous oxide combined with an oxygen concentration of 19% or 20% and 1% or traces of carbonic gas, said controlled atmosphere achieving grape preservation exceeding that achieved without such treatment.

On the other hand, European patent EP 422995, validated in Spain under publication number ES 2053144, by the same applicant as the aforesaid French patent, describes four different treatment procedures for the preservation of fresh vegetable food produce.

In particular, a first procedure is disclosed which includes an initial stage in which the products are placed at refrigeration temperature and under a pressure ranging between 0.5 and 3*10⁵ Pa, in a gaseous atmosphere initially containing at least 95% nitrous oxide, or argon, or a mixture of the two, and the products are kept under that atmosphere at refrigerated temperature and at ambient pressure in a container with a semi-permeable wall.

A second procedure is also disclosed, which is carried out in two stages, an initial stage in which the products are placed, at refrigeration temperature and under a pressure of between 0.5 and 3*10⁵ Pa, in a gaseous atmosphere initially containing 10 to 100% nitrous oxide, or argon, or a mixture of the two, and free from oxygen, for a period of time from 1 hour to 7 days, followed by a second stage in which the products are kept for at least 12 hours, at refrigerated temperature, in a second atmosphere containing 2 to 20% oxygen. In a dependent claim it is specified that a nitrous oxide concentration of 50% to 100% is preferable, while at least 95% is more preferable still, together with an oxygen concentration that is preferably between 10% and 20%.

Also disclosed is a third preservation procedure characterised in that it includes a stage of placing the products at a positive temperature lower than 20° C. in a container/chamber that comprises a semi-permeable wall and contains a gaseous atmosphere initially made up of 95% to 100% nitrous oxide, 0 to 5% oxygen, while the eventual element is an inert gas.

And finally, a fourth procedure which includes the stage of placing the products at a positive temperature lower than 20° C. in a gastight chamber that contains a gaseous mixture initially made up of 70% nitrous oxide and 30% oxygen.

In the first, third and fourth procedures the concentration of nitrous oxide is at least 95%, from 95 to 100%, and 70%, respectively.

In the first stage of the second procedure an atmosphere with an initial concentration of 10% to 100% nitrous oxide and free from oxygen is used, with a concentration of between 50 and 100% or of at least 95% nitrous oxide being preferable.

Although one of the procedures described in said Spanish patent covers a range of nitrous oxide concentrations between 10% and 100%, there is no example in which the concentration of nitrous oxide is less than 70%, while in that stage the atmosphere is furthermore free from oxygen.

Therefore, taking into account the content of these two patents which this applicant considers be the state of the art closest to the object of this invention, it is clear that a skilled man in the art would use controlled atmospheres with concentrations exceeding 90% in order to obtain the best results in a process of delaying the onset of ripening of the fruit, since it should be remembered that, in general, the recommended concentrations of nitrous oxide are of the order of 80% or higher for melons, raspberries and grapes and 70% for cherries, and that in cases in which the percentage variation of nitrous oxide is wider, that procedure is carried out in the absence of oxygen.

Furthermore, the procedures described in the state of the art present disadvantages in terms of designing facilities that permit the procedure to be carried out with a controlled modified atmosphere and in terms of cost, due to the high percentage of nitrous oxide used. All this translates into higher end-cost of the product, so that these turn out to procedures not deemed commercially useful.

### DESCRIPTION OF THE INVENTION

The object of this invention is to provide a procedure that is industrially viable, that permits delayed onset of ripening of bananas, while at the same time retaining suitable organoleptic and quality characteristics. The procedure of this invention for the preservation of bananas is characterised in that it is carried out in a non-controlled modified atmosphere, at a temperature between 12° C. and 22° C., at atmospheric pressure, in which pure nitrous oxide is introduced and is mixed with ventilation air until a nitrous oxide concentration of between 40 and 60% is obtained, and an oxygen concentration of 12% to 8%, respectively, depending on the concentration of nitrous oxide.

Advantageously, with the procedure of this invention the onset of ripening of bananas can be delayed significantly without thereby calling for sophisticated and expensive facilities that permit control of both temperature and the atmosphere present.

In particular, the procedure of the invention can be carried out during transportation of the bananas and during their storage without requiring strict temperature-control systems.

The onset of ripening can be detected easily, since it coincides with the start of a significant increase in ethylene production, as well as an increase in the carbon dioxide produced, as an effect of the banana's respiration.

A preferable embodiment of the procedure of the invention includes the use of a temperature of between 12° C. and 15° C., and more preferably 12° C., at atmospheric pressure, and introducing pure nitrous oxide which is mixed with the ventilation air until a nitrous oxide concentration of 45% to 55% is obtained, and more preferably 50%, and an oxygen concentration of 9% to 11%, and more preferably 10.5%, respectively, depending on the concentration of nitrous oxide.

Advantageously, the concentration of oxygen is determined by the concentration of nitrous oxide introduced, thereby creating an atmosphere modified automatically with reduction of oxygen. Therefore, with the procedure of this invention all that needs to be known is the concentration of nitrous oxide introduced, which undoubtedly makes it an industrially viable procedure since it does not require sophisticated systems of control of the various components of the mixture.

It is preferable to apply constant concentrations of nitrous oxide throughout the entire treatment and to carry out a continuous treatment, for this provides better results in delaying the onset of the banana's ripening.

### FIGURES

FIG. 1 shows the production of ethylene measured in nl C₂H₄/g*h in function of days from the date of harvesting. In this FIG. 1: —♦— relates to the mean of the control bananas, —▪— relates to the mean of bananas treated with 20% of N₂O for 48 hours, —▴— relates to the mean of bananas treated with 20% de N₂O for 72 hours and —X— relates to the mean of bananas treated with 20% of N₂O for 120 hours.

FIGS. 2 and 3 show ethylene and CO₂ production measured in nl C₂H₄/g*h and in mg CO₂/kg*h, respectively, in function of the days from the start of the experiment. In said FIGS. 2 and 3: —♦— relates to the values for bananas treated with 40% of N₂O up to the onset of ripening, and —▪— relates to the values for the control bananas.

FIGS. 4, 5 and 6 show the quality parameters for the bananas treated with 20% and 40% of N₂O compared with the control bananas. FIG. 4 shows the luminosity in relation to the stage of ripening, FIG. 5 shows the pulp texture in relation to the stage of ripening and FIG. 6 shows the increase of soluble solids in °Brix in relation to the stage of ripening. In those figures: —♦— relates to the control bananas, —▪— relates to the values for bananas treated with 20% of N₂O and —▴— relates to the values for bananas treated with 40% of N₂O.

FIGS. 7 and 8 show the production of ethylene and CO₂ measured in nl C₂H₄/g*h and in mg CO₂/kg*h, respectively, in function of days from the start of the experiment. In said FIGS. 7 and 8: —♦— relates to the values for bananas treated with 60% of N₂O up to the onset of ripening and —▪— relates to the values of control bananas.

FIG. 9 shows the evolution of the activity of ACC Oxidase (ACO) in the skin of bananas treated with 40% and 60% of nitrous oxide, for 10 days. In this FIG. 9: —♦— relates to the values for control bananas, —▪— relates to the values for bananas treated with 40% of N₂O and —▴— relates to the values for bananas treated with 60% of N₂O.

FIG. 10 shows the skin texture of bananas treated with 40% and 60% of nitrous oxide for 10 days. In this FIG. 10: —♦— relates to the values for control bananas, —▪— relates to the values for bananas treated with 40% of N₂O and —▴— relates to the values for bananas treated with 60% of N₂O.

FIG. 11 shows the pulp texture of bananas treated with 40% and 60% of nitrous oxide for 5 days. In this FIG. 11: —♦— relates to the values for control bananas, —▪— relates to the values for bananas treated with 40% of N₂O and —▴— relates to the values for bananas treated with 60% of N₂O.

FIGS. 12 and 13 show the increase in soluble solids and the pulp texture of bananas treated with 60% and 80% of N₂O in relation to control bananas in function of the stage of ripening. In those figures: —♦— relates to the values for control bananas, —▪— relates to the values for bananas treated with 60% of N₂O and —▴— relates to the values for bananas treated with 80% of N₂O.

### TESTS AND RESULTS

Various experiments were carried out with bananas by applying an N₂O treatment at variable concentrations. The effects of N₂O on the main quality parameters and the various biochemical and physiological parameters of the treated samples were studied in comparison with the untreated (control) samples.

All the samples were treated in advance with fungicide (1 g/l Benlate, 3 g/l Dithane), placed in closed receptacles with known air flow, and the evolution of respiration monitored using an IRGA appliance (Cosma Cristal 300) and of ethylene production (using a Carlo Erba GC 6000 gas chromatography appliance) over the course of time. The basic quality parameters of texture, soluble solids, pH and acidity were also analysed.

The tests were carried out with bananas from Ibiza and the Canary Islands, so the basic quality parameters were studied and characterised in order to be able to compare the results with Canary Islands bananas and thus find out whether or not treatment with N₂O affects the quality after differential harvesting according to the region of origin of the bananas.

In a first test, the effect of the N₂O (20%) was studied on bananas at ambient temperature (22° C.) and at a temperature of 13° C. (optimum temperature for refrigerated preservation of bananas) by comparison with untreated samples.

In a second test the effect of N₂O (20%) was studied on bananas preserved at 20° C. by means of a 20-hour treatment.

In the two trials above, the main quality parameters and physiological parameters (ethylene respiration and synthesis) were monitored throughout the ripening process. Finally, the differences between the pulp (having a clear climacteric response) and skin (non-climacteric response) were determined.

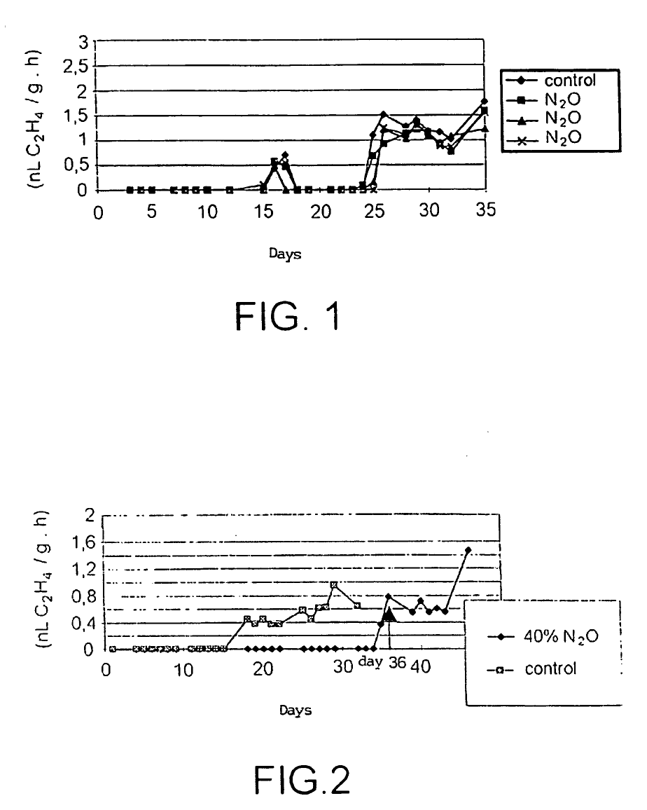

From the results obtained it was concluded that the effect of 20% N₂O on the onset of ripening of bananas was nil or practically nil, independently of time and temperature (see FIG. 1).

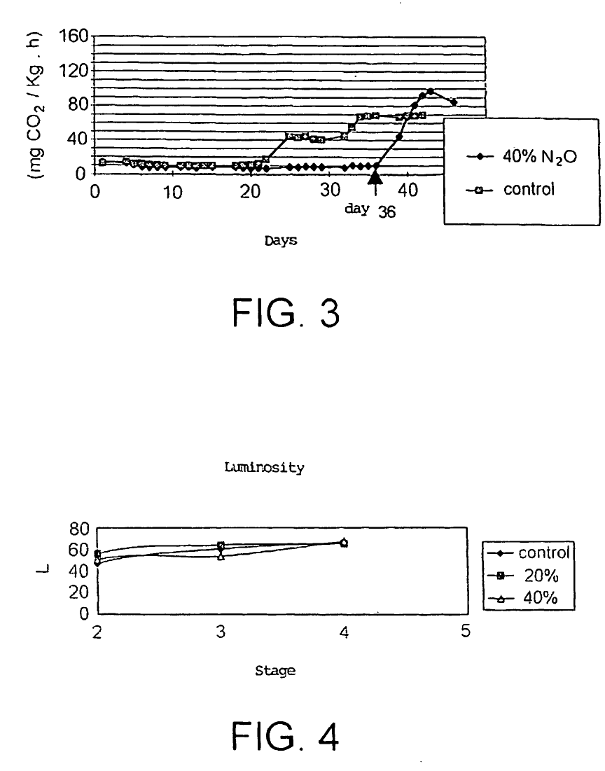

In a subsequent experiment, the bananas were submitted to a treatment with nitrous oxide at 40% and at a temperature of 20° C. In this case, the treatment was applied continuously until the onset of ripening took place, at which time application of the treatment ceased (See FIGS. 2 and 3).

From these figures it can easily be deduced that treatment with nitrous oxide at a concentration of 40% causes a significant delay in the onset of the banana's ripening, for example by 11 days in this experiment, in comparison with the control bananas.

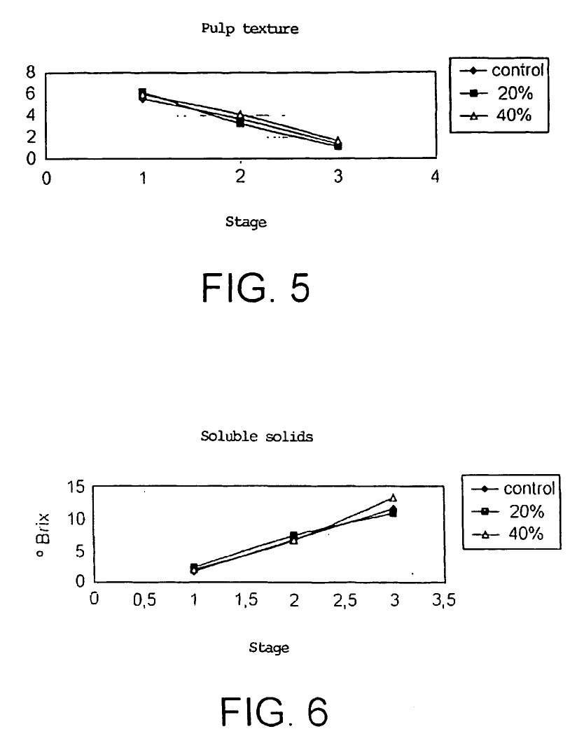

FIGS. 4, 5 and 6 show the quality parameters of control bananas and bananas treated with 20% and 40% of N₂O, respectively. Luminosity (FIG. 4) is a quality parameter that directly reflects the colour of the banana, the value being 0 for black and 100 for white. The already ripened bananas, coloured yellow, receive L values that are closer to 0 than the bananas in unripened state. From these figures it can be stated that the quality parameters for the bananas treated with 40% N₂O are similar to those of the control bananas.

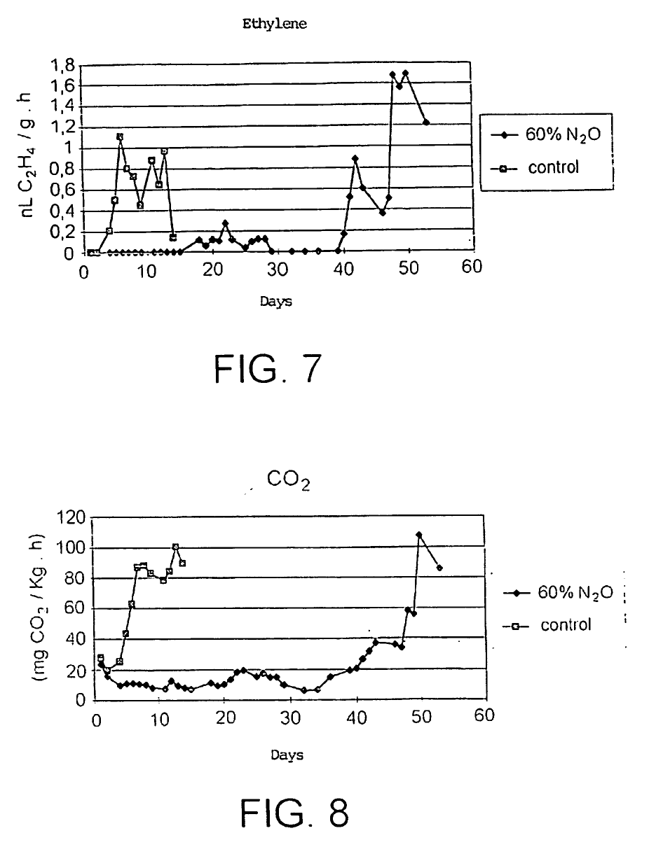

In another subsequent experiment, the bananas were subjected to treatment with nitrous oxide at 60% and at a temperature of 20° C. In this case, too, the treatment was applied continuously until the onset of ripening occurred, when the treatment was ceased. See FIGS. 7 and 8.

From these figures it can be observed that treatment with nitrous oxide at a concentration of 60% gives rise to a significant delay in the onset of the banana's ripening, for example by 40 days in this experiment, as compared with control bananas.

Therefore, although the results obtained from treatment of samples with 20% nitrous oxide for 48 and 72 h did not show significant results in delaying the onset of ripening, the experiments carried out with a treatment using 40% nitrous oxide for 120 h did show a clear ripening inhibition effect. Thus, the samples treated for 120 h with nitrous oxide showed lower inhibition in the onset of ripening, samples treated continuously showed a clear delay in the onset of ripening of the bananas, by approximately 18 days with 40% of nitrous oxide compared with the controls and by 30 days with 60% nitrous oxide.

It is important to stress, as will be detailed below, that the quality parameters were not altered negatively in the samples treated with a nitrous oxide content of 40% and 60%.

In conclusion, it may be noted that concentrations of less than 40% of N₂O do not inhibit or delay ripening of banana, and that continuous treatments with a concentration of between 40% and 60% considerably delay in the onset of ripening, by, for example, up to 30 days, while at the same time maintaining excellent fruit quality and organoleptic properties.

The delay in the onset of ripening obtained in tests with 40 and 60% concentrations of nitrous oxide is shown in ethylene production and also in the activity of ACO, the enzyme responsible for the biosynthesis of ethylene from its immediate precursor. Clendenen et al showed that the maximum expression of ACO arose on the skin, especially in the zone closest to the pulp; it is nevertheless known that minimum ACO activity in pulp is necessary and essential for the onset of self-catalysing synthesis of ethylene in skin.

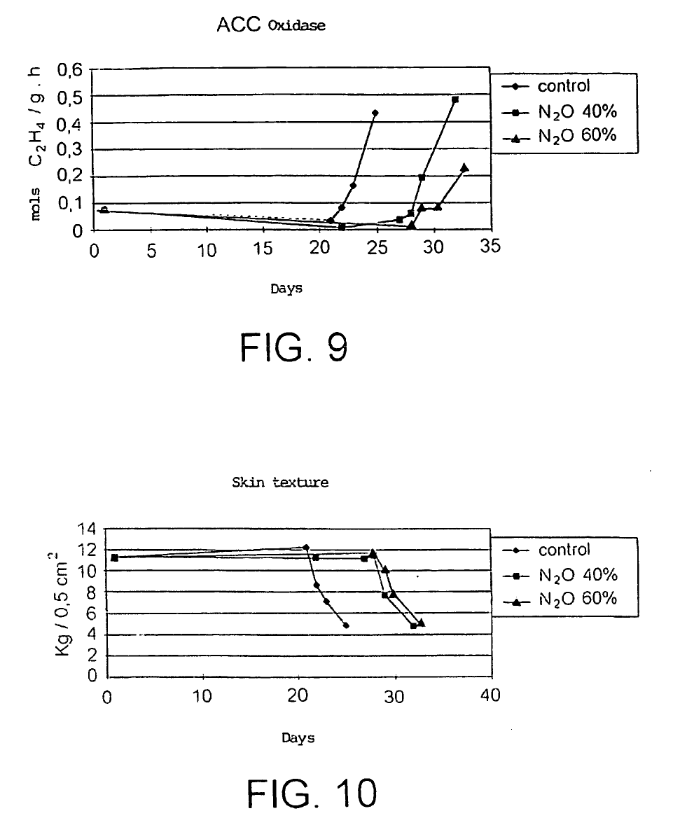

FIG. 9 shows that the evolution of the activity of ACC Oxidase (ACO) in the skins of bananas treated both with 40% and 60% concentrations of nitrous oxide for 10 days is comparable to the evolution of the ACO activity in control bananas.

Since the banana is a climacteric fruit, its ripening process is regulated by the endogenous levels of ethylene and, therefore, all the studied parameters related with ripening in the treated bananas were concomitantly affected by the levels of ethylene produced. The follow were therefore delayed: the onset of climacteric respiration, the increase in soluble solids (sugars), reduction in firmness of the fruit and changes in measurable pH and acidity associated with ripening. None of the treatments applied with 40 or 60% N₂O had a negative effect on the quality parameters analysed: delay in the onset of the climacteric involved maintenance of quality parameters within the same levels as in the preclimacteric samples, and on reaching climacteric remained within normal levels in relation to the untreated samples. The quality parameters (texture, acidity and pH) were not affected by the treatment, except in their evolution over time, and it was observed that they depend exclusively on ethylene levels in the sample.

In order to analyse the basic quality parameters and the physiology and biochemistry of the treated bananas, treatments with nitrous oxide were carried out at concentrations of 40 and 60% in bananas preserved under normal refrigeration (20° C.). Most of the experiments were also carried out at 12° C.

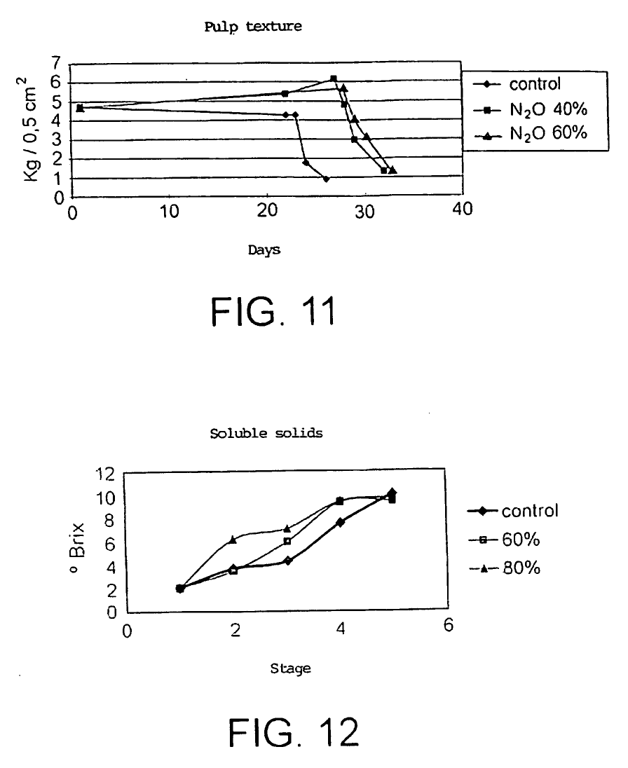

FIGS. 10 and 11 show that skin texture and pulp texture in bananas treated with 40% and 60% concentrations of nitrous oxide are comparable to those of the control bananas.

Although experiments carried out with an 80% concentration of nitrous oxide showed a rather longer delay in the onset of the banana's ripening, the quality characteristics of the fruit were not satisfactory. In particular, the fruit treated with 80% nitrous oxide did not undergo a normal banana ripening process, a fact clearly shown in the anomalous skin colouration and advanced ripening of the pulp compared with that of the skin. Moreover, the bananas treated with a nitrous oxide concentration of 80% did not develop a homogeneous skin colour all over the banana's surface, for some zones had a brownish-yellow colour while others were still green, under the effect of poor de-greening of the skin.

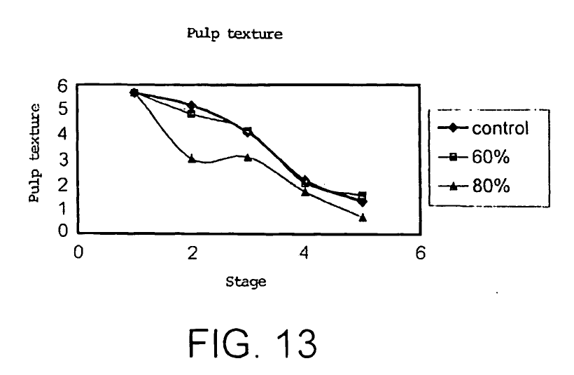

FIGS. 12 and 13 show the quality parameters in relation to stages E1 (unripe banana), E3 (start of the climacteric), E4 (following the climacteric peak) and E5 (fully ripe banana). In particular, in FIG. 12 it can be observed that the bananas treated with 80% nitrous oxide show an increase of soluble solids at a stage preceding that of the bananas treated with a 60% concentration and the control bananas. This is indicative of the pulp degradating more rapidly than in the bananas treated with a 60% concentration and the control bananas. FIG. 13 shows that the pulp texture of the bananas treated with 80% nitrous oxide ripens more quickly than the skin texture when compared with the bananas treated with 60% and the control bananas.

1. Procedure for the preservation of bananas, comprising it is carried out in non-controlled modified atmosphere, at a temperature of between 12° C. and 22° C., under atmospheric pressure, in which pure nitrous oxide is introduced and is mixed with ventilation air until a nitrous oxide concentration of between 40 and 60% is obtained, and an oxygen concentration of 12% to 8%, respectively, depending on the concentration of nitrous oxide, and in that a continuous treatment is carried out up to the onset of ripening.

2. Procedure for the preservation of bananas according to claim 1, in which the temperature is between 12° C. and 15° C.

3. Procedure for the preservation of bananas according to claim 2, in which the temperature is 12° C.

4. Procedure for the preservation of bananas according to claim 1, in which the nitrous oxide concentration of is between 45% and 55%, and the oxygen concentration is between 11% and 9%, respectively.

5. Procedure for the preservation of bananas according to claim 4, in which the concentration of nitrous oxide is 50% and the concentration of oxygen 10.5%, respectively.
